(19) United States
(12) Patent Application Publication
(10) Pub. No.: US 2015/0251306 A1
(43) Pub. Date: Sep. 10, 2015

(54) Tubular grip

(71) Applicant: Eric Ashton Paul, Durango, CO (US)

(72) Inventor: Eric Ashton Paul, Durango, CO (US)

(21) Appl. No.: 14/201,701

(22) Filed: Mar. 7, 2014

(51) Int. Cl. B25G 1/10

(52) U.S. Cl. CPC B25G 1/102

(57) ABSTRACT

A tubular grip with off-center longitudinal slot for carrying and displacing weight by placing the grip on the bottom edge of building material panel: Concrete board, Plywood, Offset Strand board, Sheet Rock, and other such materials.

### RELATED U.S. PATENT DOCUMENTS

D. 255,317 June 1980 Slinkard

D. 268,477 April 1983 Underdabl

D. 286,972 December 1986 Crews

D. 302,234 July 1989 McNamee et al

D. 317,703 June 1991 Cydrus

D. 402,468 December 1998 Killins

### BACKGROUND OF THE INVENTION

The present invention relates to a panel carrying device that grips without damaging fragile material at the same time protecting the lifting hand from possible injury and or fatigue of repeated griping of edges on various building panels. This invention consists of a tube with an off-center longitudinal slot.

### DESCRIPTION OF PRIOR ART

The size of most panels are 4×8 feet and 60 to 80 pounds depending on the material, this weight can be moved by one person by hand although the pressure lands in an area ½ an inch and as wide as that persons hand about 4 inches. The large quantity of these panels and the distance they have to be moved can be overwhelming and a very good reason for tools of this nature.

The panel carriers of the prior art seem to consist of a grip and some form of hook to support the panel, some are taller around a foot others are more compact 4 or 5 inches but none as simple and to the point as my invention. I found the universal article carrier U.S. Pat. Des. 402,468 to direct a binding pressure that cracked drywall, the thong type grip was very painful to lift with, and the hook would slip and slide across the downward edge of the panel with poor griping action.

The other handgrips similar in form U.S. Pat. Nos. Leonard (4,846,519) and Elliott (2,444,558) serve the same purpose in that they aid to carry more weight and reduce strain to the hand, but these hand grips are for shopping bags therefore have a narrow slot on center that could only accept thin cord or plastic bag handles.

### SUMMARY OF THE INVENTION

The key features of the present invention are a tubular hand grip device, a longitudinal off-center slot for receiving and gripping building material panels, and a concentric inner bore.

The tubular hand grip device, composed of rigid plastic, distributes the weight of said panel evenly across the fingers, and palm. The tubular hand grip device also provides a supportive resting place for the said panel without crushing or damaging at any point of contact.

A longitudinal off-center slot for receiving and gripping building material panels that gently holds the building panel with the rotation incurred from the bores inner curve forcing the panel back to the center from the simultaneous downward pressure of said panel.

A concentric inner bore produces a solid contact on each side of the slot and longitudinally down the bore opposite the slot.

### BRIEF DESCRIPTION OF THE DRAWINGS

FIG. 1 is a perspective view of a tubular grip for carrying building material panel.

FIG. 2 is a perspective view of a tubular grip for carrying building material with grip applied to said building material panel.

### DETAILED DESCRIPTION OF THE INVENTION

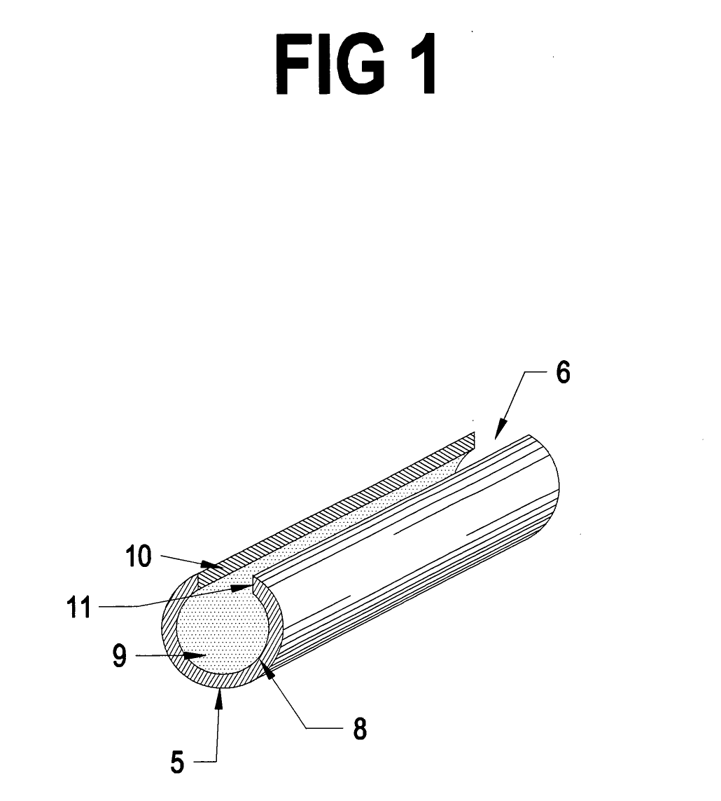

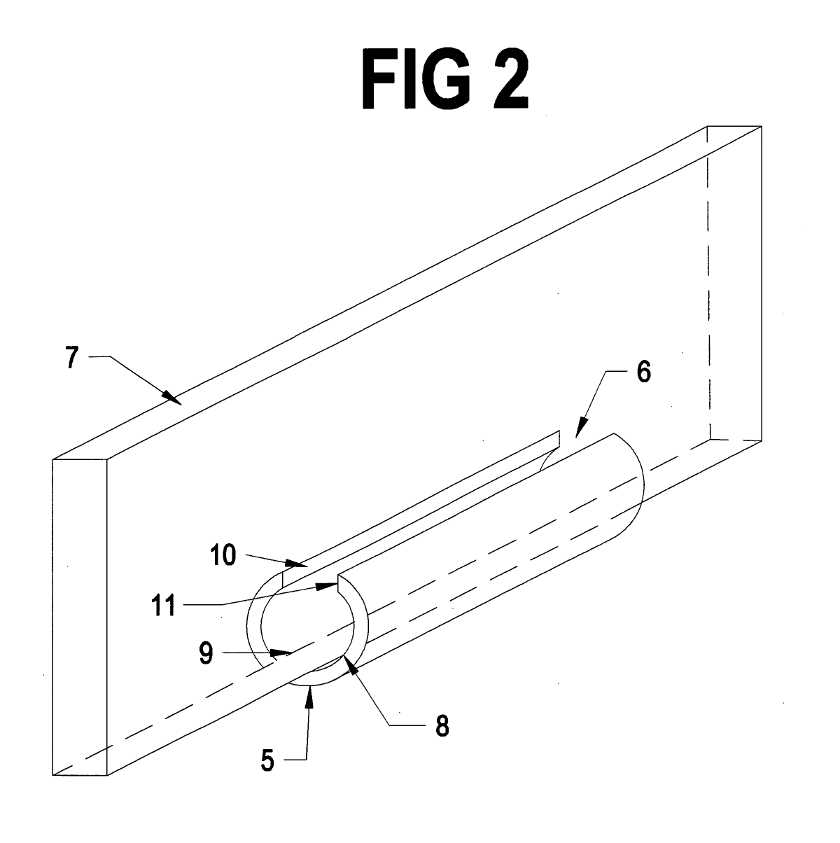

As shown in FIG. 1 the present invention 5 a tubular grip with off-center longitudinal slot 6 for carrying and displacing weight by placing the grip 5 on the bottom edge of building material panel 7 as shown in FIG. 2.

The tubular grip 5 approximately 4.25″ long, 1.00″ outside diameter, 0.80″ inside diameter, with 0.05″ off-center longitudinal slot 6, and 0.45″ wide slot or 0.05″ smaller opening 6 than said panel 7. The tubular grip 5 cut from rigid plastic or molded.

The longitudinal off-center slot 6 for receiving and gripping building material panels that gently holds 8, 10, and 11 the building panel 7 with the rotation incurred from the bores inner curve 8 forcing the panel back to the center from the simultaneous downward pressure of said panel 7 as in FIG. 2.

The tubular hand grip device 5 also provides a supportive resting place 9 for the said panel 7 without crushing or damaging at any point of contact 8, 9, 10, 11 as in FIG. 2.

1) A tubular grip with off-center longitudinal slot for carrying and displacing weight by placing the grip on the bottom edge of building material panel will grip the said panel by the rotation incurred from the weight of the said panel pushing down the bores inner curve. When said panel is lifted the grip becomes more secure and less likely to slip or slide, as when said panel is set on angle to be carried up a stairway.

2) A tubular grip with off-center longitudinal slot for carrying and displacing weight by placing the grip on the bottom edge of building material panel will protect said panel from damage and breakage by supporting and griping along liner points of contact inside of the off-center slot and longitudinally down the bore of the tubular grip.

3) A tubular grip with off-center longitudinal slot for carrying and displacing weight by placing the grip on the bottom edge of building material panel provides a larger griping surface to support the said panel and ease strain and protect the users hand from hazardous materials, and splinters.
